(19) United States
(12) Patent Application Publication
(10) Pub. No.: US 2011/0040788 A1
(43) Pub. Date: Feb. 17, 2011

(54) Coherent File State System Distributed Among Workspace Clients

(75) Inventor: ROGER MARCH, SANTA CLARA, CA (US)

Correspondence Address: PATENTRY, P.O. BOX 151616, SAN RAFAEL, CA, 94915-1616, US

(73) Assignee: IC MANAGE, INC., LOS GATOS, CA (US)

(21) Appl. No.: 12/541,883

(22) Filed: Aug. 14, 2009

(51) Int. Cl. G06F 17/30; G06F 12/16

(52) U.S. Cl. 707/770; 726/3; 707/E17.032; 711/E12.001; 711/E12.103

(57) ABSTRACT

A system comprising at least one file state server and a plurality of network attached workspace client apparatuses; operating the file state server by receiving an update to a version tracking record from each workspace client apparatus whenever a new or modified file is committed into a file system view, by archiving every version of every committed file, by transmitting a version tracking parameter to a workspace client apparatus in response to a query as to the data freshness of a certain file in a file system view, and by updating a workspace client apparatus with a list of peer workspace client apparatuses; operating the workspace client apparatus by aging files and removing the least recently used file from local store, exchanging file system views of committed files with peer workspace client apparatuses, updating a list of peer workspace client apparatuses, requesting a data block of a committed file from a peer workspace client apparatus, transmitting an archive copy and a version tracking parameter to a file state server for each file committed into a file system view, and querying a file state server for a version tracking parameter for a data block read request.

### BACKGROUND

In a large interdisciplinary engineering project spanning multiple timezones, each participant may require read-only access to thousands of files while retaining write authority to only a few hundred. Some of the files are related in a logical hierarchy while others are related in a physical hierarchy. Many of the files evolve over time and participants may at one time want access to the most recent version of a certain file and at others desire a stable collation. Thus the files that concern one participant will be different from another and multiple versions of a certain file may be appropriate for various roles.

Moreover concentration of files into centralized servers has been observed to increase congestion and lower both accessibility and reliability. Centralized servers require heavier investment in information technology and redundancy while duplicating storage.

Referring now to FIG. 1, it is known that a user 111 operating a workstation 112 may read and write files on a local file store 113 as well as on network attached file stores coupled to workstations 122 and servers 182. Lack of version control, poor security, and excessive disk usage are common byproducts of this architecture. Substantial congestion has been observed if all files are exclusively stored in a centralized server.

Thus it can be appreciated that what is needed is coherent management of all files committed to a project with distributed storage and improved data block accessibility.

### SUMMARY OF THE INVENTION

The present invention comprises a system comprising at least one file state server and a plurality of network attached workspace client apparatuses each with local store.

The present invention comprises a method for operating the file state server comprising
receiving an update to a version tracking record from each workspace client apparatus whenever a new or modified file is committed into a file system view,
transmitting a version tracking parameter to a workspace client apparatus in response to a query as to the data freshness of a certain file in a file system view, and in an embodiment,
updating a workspace client apparatus with a list of peer workspace client apparatuses.

The present invention comprises a method for operating the workspace client apparatus comprising the steps:
transmitting a content point value and a change log serial value to a file state server for each managed file when it is committed,
requesting a content point value and a change log serial value from a file state server for each managed file when it is read,
determining at least one storage location of a change log and a content point of a file, and
retrieving a block of a file consistent with a content point and a change log consistent with a change log serial value and applying changes to the block if necessary.

The present invention comprises a method for operating the workspace client apparatus further comprising
aging files in a file system view and removing the least recently used file from local store,
exchanging file system views with peer workspace client apparatuses,
updating a list of peer workspace client apparatuses if needed,
requesting a data block from a peer workspace client apparatus if a suitable version is not locally stored,
transmitting a version tracking parameter to a file state server for each new or modified file committed into a file system view by a user, and
querying a file state server for a version tracking parameter for each data block read request from a user operating the workspace client apparatus.

The present invention is a method for operating a system comprising the steps:

within each workspace client apparatus

exchanging with other workspace clients file information,

responding to requests for managed file from a workstation,

presenting a file state view to a user,

updating a file state server with state information for each file in the file state view.

within a file state server apparatus

receiving and serving file state information,

stashing redundant file copies at workspace clients which do not have a file state view of them,

writing every version of every managed file into archive store.

In an embodiment the method further comprises receiving, storing, retrieving and serving a hierarchical tree of data blocks comprising data blocks which are encrypted and data blocks which are not encrypted whereby a file system view circuit can provide its peers with data blocks which the file system view circuit cannot itself decipher for its own use.

In an embodiment the method for committing a file comprises the following processes:
making a file visible to all peers,
archiving a file to a central store,
updating a file state server with a new version control parameter, and
updating a file system view of the file from pre-managed to managed.

### BRIEF DESCRIPTION OF DRAWINGS

FIG. 1 is a block diagram of a conventional system operating over a network provided as background. FIG. 2, 3, 4, 5, 6, are data flow diagrams of processes within a block diagram of involved components of a system operating over a network.

FIG. 7 is a hierarchical block diagram of components of apparatus in a system.

FIGS. 8, 9, 10, 11 and 12 are dataflow diagrams between blocks in a system illustrative of steps in a method.

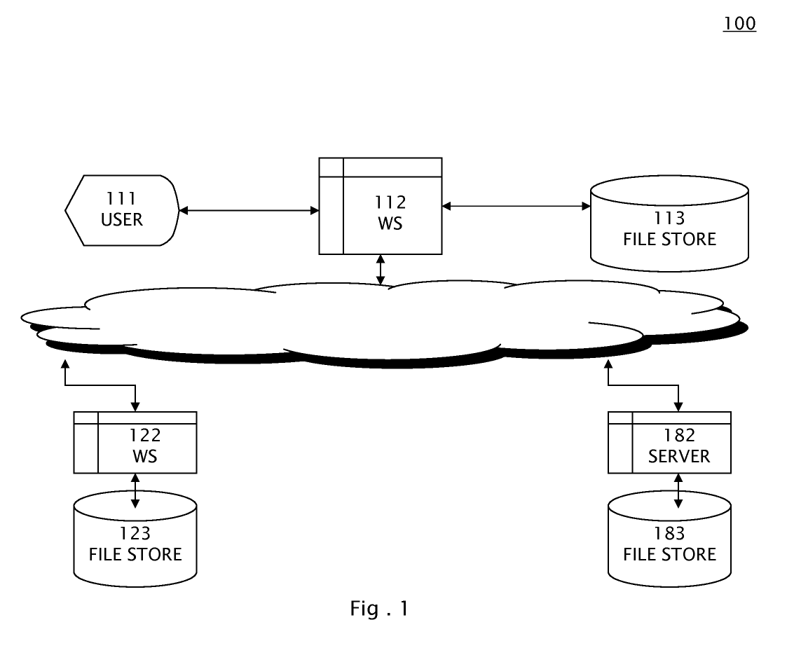

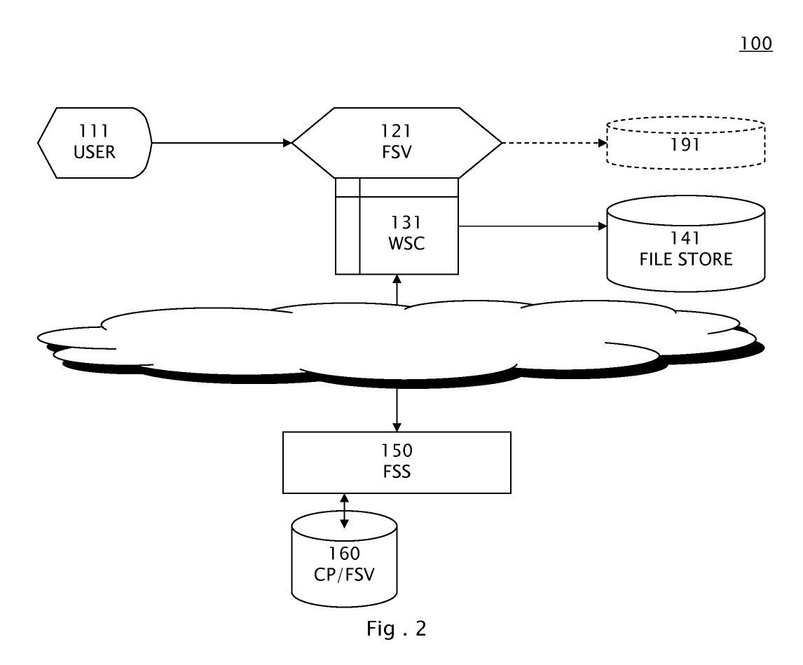

### DETAILED DISCLOSURE OF THE EMBODIMENTS

Referring now to FIG. 2, the present invention comprises a workspace client apparatus 131 coupled to a local file store 141, the workspace client apparatus comprising a file state view circuit 121 coupled to a user interface 111. The workspace client apparatus 131 is further coupled through a network to a file state server 150. The file state server comprises a content point store 160 for each file state view for each user.

The method of operating the workspace client apparatus is to present to the user a file system view of a virtual store 191. When a user commits a file in the file system view, the access is intercepted by the workspace client and in an example written to a locally attached file store 141. The workspace client further communicates the change in state to the file system server 150 which records the change in file state in the content point store 160 for this particular user's file state view and archives the new version.

In an embodiment, the workspace client 131 also receives information about its peer workspace clients.

Referring now to FIG. 3, when a user 111 requires a block of a file that is accessible to him according to file state view 121 this access is intercepted and received by the workspace client 131 which queries the file state server for the current content point and change log serial. If not in file store 141, workspace client 131 transfers a request to workspace client 132 and receives the file.

Referring now to figure for 4, the method for operating a workspace client further comprises the step of exchanging further file system view information with peer workspace clients. In this illustration neither workspace client 131 nor workspace client 132 have the file requested by the user however workspace client 132 indicates that the desired file is located in the file store 143 attached to workspace client 133 which is requested and returned.

Referring now to FIG. 5, the method for operating a workstation client further comprises the step when no workstation client known to workstation client 131 can locate the requested file, asking the file state server 150 for another workspace client 134 to be queried. Only if unsuccessful in querying peers will the central archive be accessed.

Referring now to FIG. 6, in an embodiment when files are located at a plurality of file stores different pieces of the file can be requested from each file store taking advantage of high-bandwidth to deliver parts of the file simultaneously.

In an embodiment, a workspace client can determine to stash a file locally for redundancy and performance without making the file visible in the file state view of a certain user.

In an embodiment, the file state server can maintain a plurality of content points for different users and control access through the file state views. The workspace client also removes inactive content points which are unneeded by any user i.e. not in its file state view.

In an embodiment the present invention comprises a system for improved serving of versioned files to a plurality of users operating on a shared hierarchical file system comprising
a network coupled to
at least one file state server apparatus,
the network further coupled to
a plurality of workspace client apparatus
   wherein each workspace client apparatus comprises
a local file store,
a network adapter,
a user interface,
a file system view circuit,
   wherein the file system view circuit presents to each user a display of
his premanaged files, and
managed files visible to all users, wherein managed files comprise change logs and content points;
   wherein a file state server apparatus comprises
a network adapter,
a temporal store,
a temporal circuit, and
a workspace client store
   wherein the temporal circuit receives and transmits the change logs and content points of each managed file and which content point are active for each file system view, and
   wherein the workspace client store receives and transmits the identities and network address of every attached workspace client apparatus.

The present invention comprises a method for operating a system comprising the steps:

within each workspace client apparatus
exchanging with other workspace clients file information,
responding to a request for a managed file from a workstation,
presenting a file state view to a user,
updating a file state server with state information for each file in the file state view.

In an embodiment the present invention comprises a file state server apparatus comprising

a processor coupled to a plurality of stores and to a network adapter, the processor adapted to
maintain the temporal state of files in workspace clients.

In an embodiment, a file state server apparatus further comprises a file store.

In an embodiment the method for operating file state server comprises:
providing likely candidate workspaces to provide the files
providing the files from its own file store
controlling the access rights for managed files,
updating workspace clients about changes in other workspace clients

In an embodiment the file state server provides a managed file to a workspace client. In an embodiment a workspace client stores redundant file copies which are not presented to a file state view.

The present invention is a method for operating a workspace client apparatus comprising the following processes:

updating managed file information comprising
receiving information about workspace clients from other workspace clients
receiving information about workspace clients from the file state server
   presenting a file system view of files managed by the file state server to all users,
   presenting a file system view of pre-managed files local to the workspace client only to the owner of a pre-managed file,
   providing managed files to other workspace clients,
   upon receiving a network request for a managed file from a peer workspace client,
examining local file store for requested file,
transmitting change log for requested file,
transmitting content point for request file,
transmitting identities of workspace clients known to have the requested file,
exchanging updated file state views of managed files;
   upon receiving a local user file write
storing the file to locally attached file store,
   if the file is a managed file,
determining a change log to a content point,
transmitting to a file state server apparatus the current file state,
transmitting to a file state server apparatus the file store location,
updating the file system view, and
archiving a new version of the file;
   upon receiving a local user file read
retrieving the file from locally attached store,
if the file is a managed file not in locally attached file store,
If possible, satisfies request from within its current holdings
If possible, satisfies request from other workspace client,
Otherwise, identifying another workspace client.

In an embodiment, the method for operating a workspace client further comprises
receiving a change log for a file,
receiving a content point for a file,
receiving and combining file parts from a plurality of sources.

In an embodiment the method for operating a workspace client further comprises:
optimizing workspace client information exchange
maintaining change logs over a finite range
exchanging only incremental changes if possible and,
otherwise, exchanging full state,

In an embodiment, the method for operating a workspace client further comprises:
choosing suitable peer workspace clients based on similar file system views to request blocks from,
collecting statistics about performance and reliability of other workspace clients to prioritize block requests, and recording the frequency of network link failures to
determine redundant resource gaps.

In an embodiment, the network is an encrypted ssl tunnel.

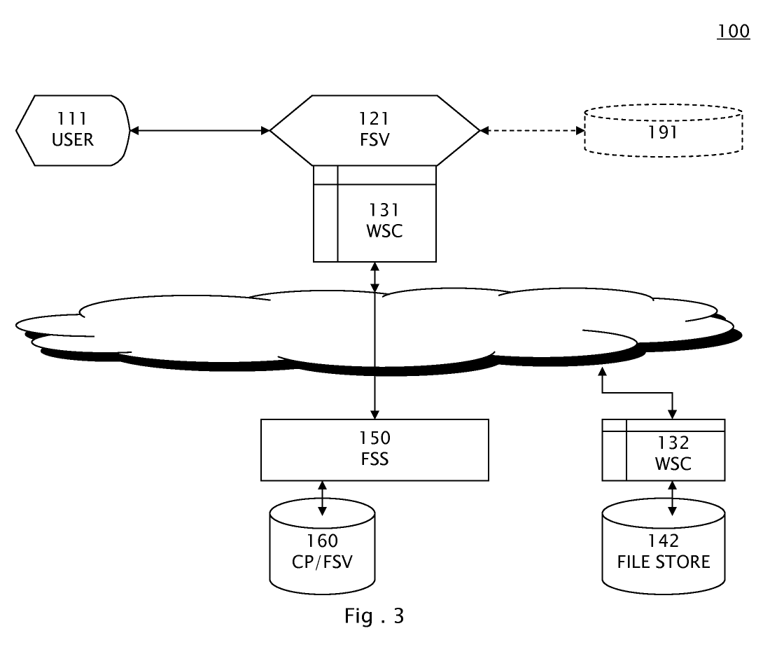

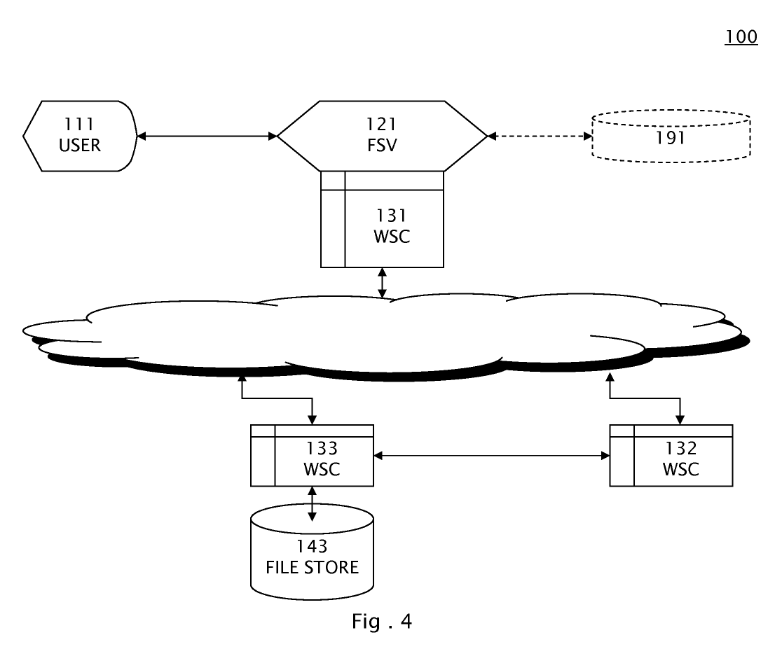

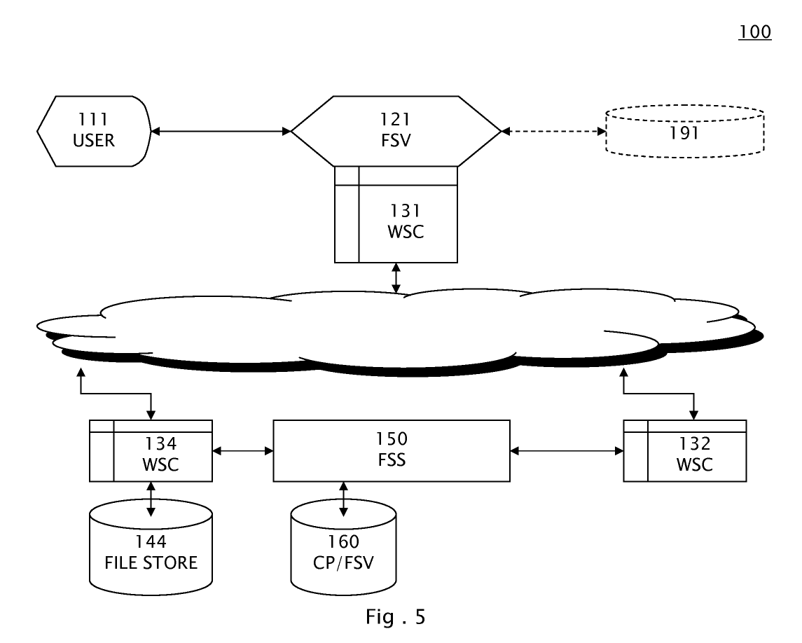

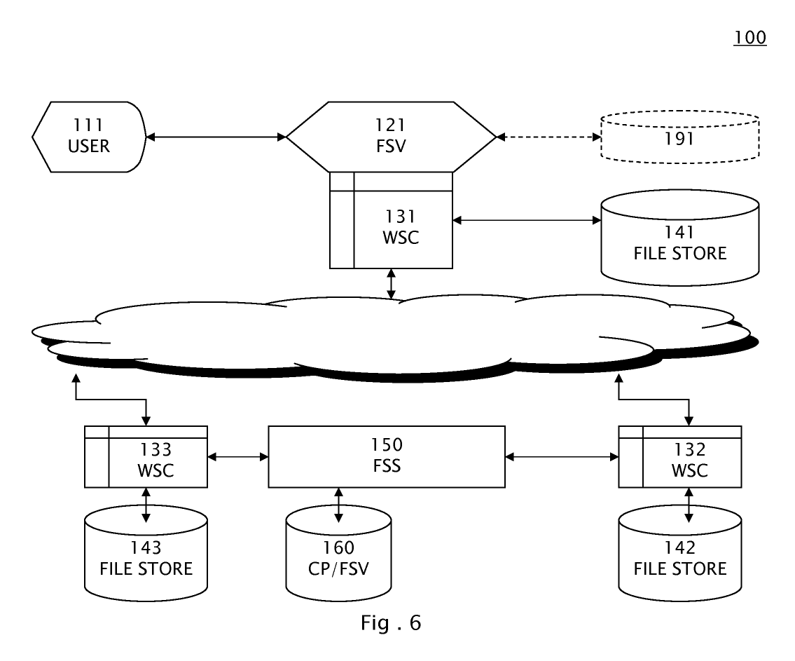

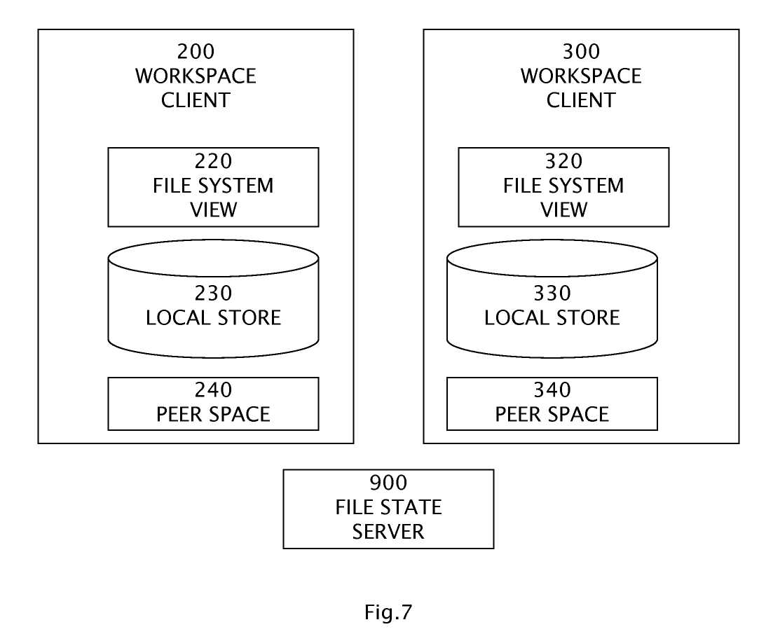

Referring to FIG. 7, an embodiment comprises a file state server 900 and a plurality of workspace client apparatuses 200, 300, . . . each workspace client apparatus comprising
a local store,
a file system view circuit, and
a peer space circuit.

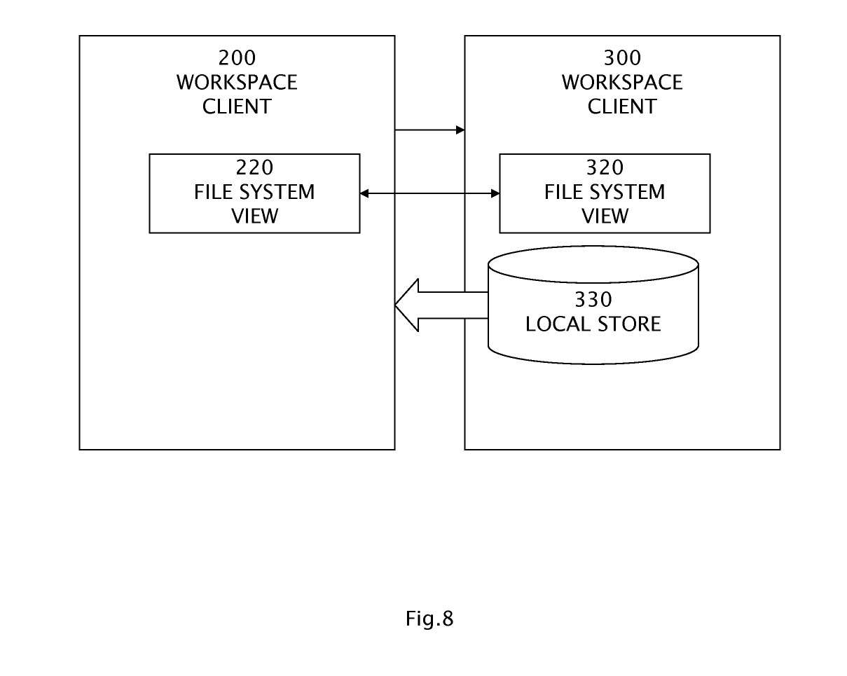

Referring to FIG. 8, a method for operating a workspace client, comprises the steps following:
recording each access by user to each file in file system view,
removing least recently used files which are read only,
receiving a request from a peer client apparatus for a certain block of a certain file,
determining if the requested block is stored in the local store 330,
if stored, transmitting the requested block to the peer client apparatus 200, and
exchanging file system view updates between the workspace clients.

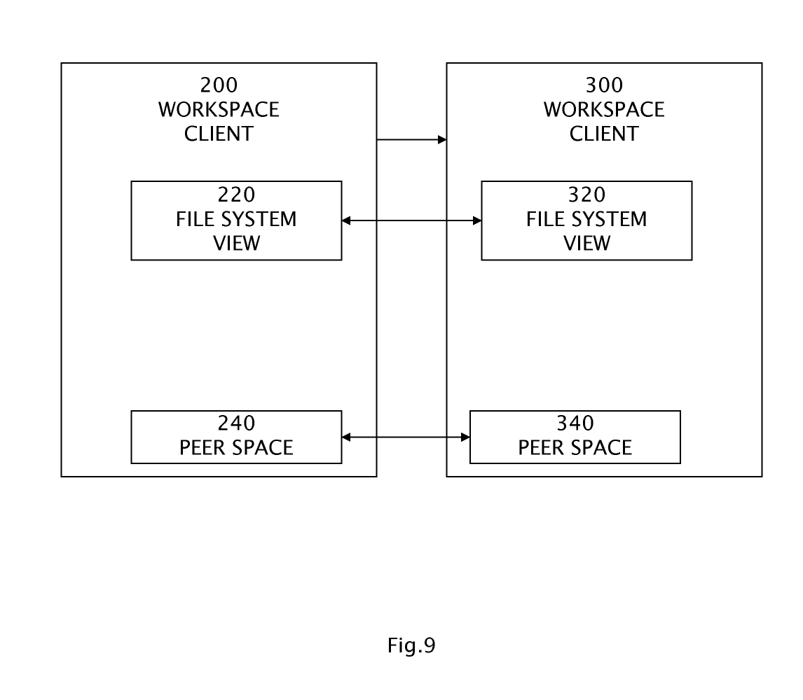

Referring to FIG. 9, in an embodiment, the method further comprises the step of exchanging peer space updates in the case that the workspace client determines that the requested block is not stored in the local store.

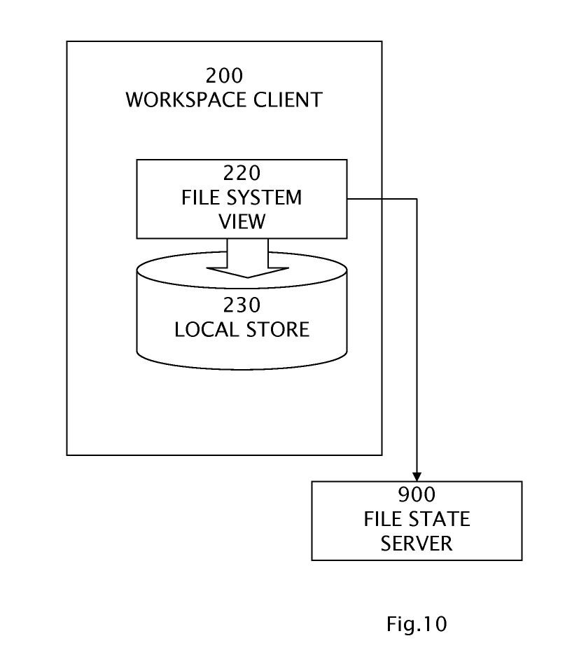

Referring to FIG. 10, a method for operating a system comprising a file state server 900 and a workspace client 200, comprises the steps:
recording each access by a user to a file in file system view,
removing from local store least recently used files,
committing a new or changed file to local store 230,
updating a file system view circuit 220 with a change log or initial content point of the file, and
updating a file state server with the status of the new or changed file.

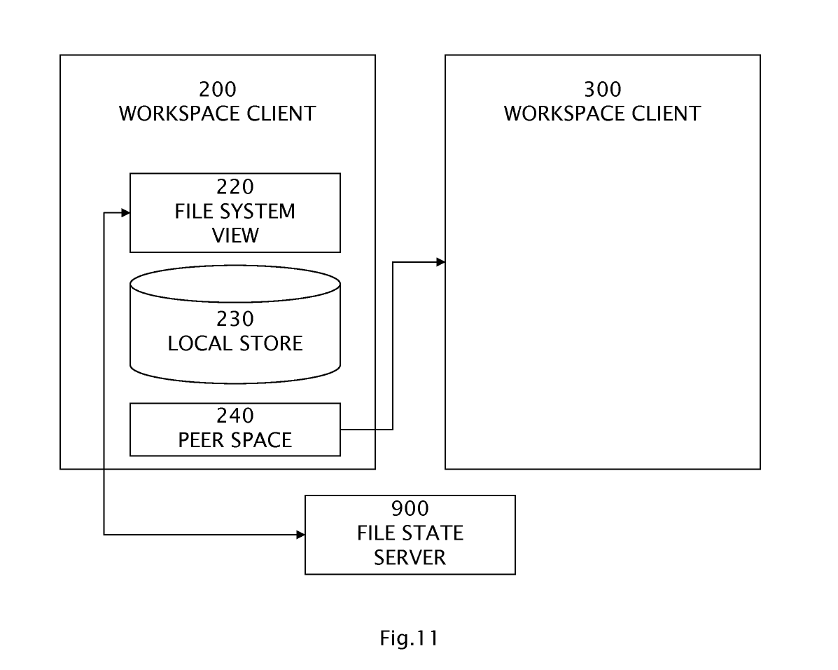

Referring to FIG. 11, the method for operating a system comprises the following steps
within a second workspace client 300, receiving a request for a certain block from a peer workspace client 200,
within a file state server 900, receiving a request from a first workspace client 200 and transmitting the current status of a certain file;
within a first workspace client 200,
intercepting at least one file block read requested by a user,
requesting a current status of the file from the file state server 900,
determining that at least one block of the current file is not within the local store 230,
obtaining at least one candidate peer workspace client from a peer space circuit 240, and
transmitting a block request to at least one peer workspace client 300.

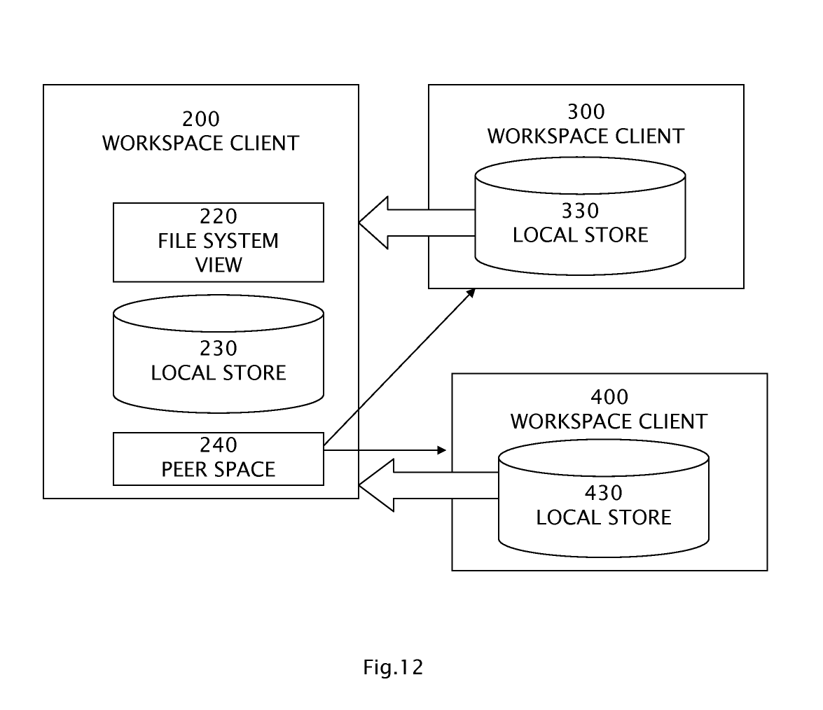

Referring to FIG. 12, in an embodiment, the method further comprises
determining that a first block is not in local store 230 and a second block is not in local store 230,
requesting a first block from a first peer workspace client 300;
requesting a second block from a second peer workspace client 400; and
integrating the blocks for the user of workspace client 200.

In an embodiment, the method for operating a file state server comprises:
receiving and storing each change in file system view from each workspace client,
responding to a workspace client request with the current versions of each file.

In an embodiment the method further comprises the step of responding to a first workspace client request with at least one peer workspace client not previously known to the first workspace client.

In an embodiment the method for operating a workspace client comprises:
committing a file or modified file into a file system view,
intercepting a block read request of a certain committed file,
requesting the current revision number for a certain committed file from a file state server,
determining if local store contains a current revision of a certain committed file,
examining file system views of peer workspace clients to locate a current revision of a certain committed file,
requesting transfer of a block of a certain committed file from a peer workstation client,
recording each access to each file in file system view, and
removing from local store a least recently used file.

### CONCLUSION

The present invention is easily distinguished from conventional network file systems and source code control solutions by its file state server which tracks every version of every managed file and its plurality of network attached workspace client apparatuses which respond to requests for randomly accessible blocks of files among themselves. It can be appreciated that that a conventional network file system has no concept of disjoint file views where each user is concerned with a snapshot of every file at a point in time.

The present invention is distinguished from conventional source code control solutions by operating the file state server to receive an update to a version tracking record from each workspace client apparatus whenever a new or modified file is committed into a file system view, and to transmit a version tracking parameter to a workspace client apparatus in response to a query as to the data freshness of a certain file in a file system view. In an embodiment, the file state server provides a workspace client apparatus with a list of peer workspace client apparatuses. To avoid congestion, queries for a certain file to all peer workspace clients are exhausted before retrieval from a centralized archive store. The present invention is easily distinguished from conventional source code control systems by averting massive duplication of files among every user of each file.

The present invention is distinguished from conventional peer to peer file sharing by operating the workspace client apparatus
to age files in a file system view and remove the least recently used file from local store,
to exchange file system views with peer workspace client apparatuses,
to update a list of peer workspace client apparatuses if needed,
to request a data block from a peer workspace client apparatus if a suitable version is not locally stored,
to transmit a version tracking parameter to a file state server for each new or modified file committed into a file system view by a user,
to allow selectable access to every version of every managed file, and
to query a file state server for a version tracking parameter for each data block read request from a user operating the workspace client apparatus.

It is a distinguishing characteristic that workspace clients respond to requests for randomly accessed data blocks rather than whole file transfers and that workspace clients request version tracking parameters from a file state server before fulfilling data reads with local stored data blocks.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

A number of embodiments of the invention have been described. Nevertheless, it will be understood that various modifications may be made without departing from the spirit and scope of the invention. For example, other network topologies may be used. Accordingly, other embodiments are within the scope of the following claims.

What is claimed is:

1. A system comprising at least one file state server and a plurality of network attached workspace client apparatuses;
wherein a file state server comprises a processor adapted by a software program product to
record all workspace clients where managed file content is stored,
maintain the temporal state of files in workspace clients,

2. The system of claim 1 wherein a workspace client apparatus comprises
a local store,
a file system view circuit,
a peer space circuit, and
a processor adapted by a software program product to update managed file information,
present a file system view of files accessible to a user, and
present a view of premanaged files accessible to a user.

3. The processor of claim 2 further adapted by a software program product to
provide managed files to a network connected workspace client,
receive a network request for a block of a managed file from a peer workspace client. intercept a user file read, and
request a data block from a peer if not found in local store.

4. A method for operating a file state server comprising
receiving an update to a version tracking record from each workspace client apparatus whenever a new or modified file is committed into a file system view,
transmitting a version tracking parameter to a workspace client apparatus in response to a query as to the data freshness of a certain file in a file system view, and
updating a workspace client apparatus with a list of peer workspace client apparatuses.

5. A method for operating a workspace client apparatus comprising
transmitting a content point value and a change log serial value to a file state server for each managed file when it is committed, and
requesting a content point value and a change log serial value from a file state server for each managed file when it is read.

6. The method of claim 5 further comprising:
determining at least one storage location of a change log and a content point of a file, and
retrieving a block of a file consistent with a content point and a change log consistent with a change log serial value and applying changes to the block if necessary.

7. The method of claim 5 further comprising:
aging files in a file system view and removing the least recently used file from local store,
exchanging file system views with peer workspace client apparatuses, and
updating a list of peer workspace client apparatuses if needed.

8. The method of claim 7 further comprising:
requesting a data block from a peer workspace client apparatus if a suitable version is not locally stored,
transmitting a version tracking parameter to a file state server for each new or modified file committed into a file system view by a user, and
querying a file state server for a version tracking parameter for each data block read request from a user operating the workspace client apparatus.

9. The method of claim 5 for operating a workspace client, the workspace client apparatus comprising
a network interface,
a local store, and
a file system view circuit,
the method comprising the steps following:
recording each access by user to each file in file system view,
removing least recently used files which are read only,
receiving a request from a peer client apparatus for a certain block of a certain file,
determining if the requested block is stored in the local store,
if stored transmitting the requested block to the peer client apparatus, and
exchanging file system view updates between the workspace clients.

10. A method for operating a system comprising the following steps within a second workspace client,
receiving a request for a certain block from a peer workspace client,
within a file state server,
receiving a request from a first workspace client and transmitting the current status of a certain file;
within a first workspace client,
intercepting at least one file block read requested by a user,
requesting a current status of the file from the file state server,
determining that at least one block of the current file is not within the local store,
obtaining at least one candidate peer workspace client from a peer space circuit, and
transmitting a block request to at least one peer workspace client.

11. The method of claim 10 further comprising,
determining that a first block is not in local store and a second block is not in local store,
requesting a first block from a first peer workspace client;
requesting a second block from a second peer workspace client; and
integrating the blocks for the user of workspace client.

12. A system for coherent file state management comprising
a network coupled to
at least one file state server apparatus,
the network further coupled to
a plurality of workspace client apparatus
wherein each workspace client apparatus comprises
a local file store,
a network adapter,
a user interface,
a file system view circuit,
wherein the file system view circuit presents to the user a display of pre-managed files, and
managed files, wherein managed files comprise change logs and content points;
wherein a file state server apparatus comprises
a network adapter,
a temporal store,
a temporal circuit, and
a workspace client store
wherein the temporal circuit receives and transmits the change logs and content points of each managed file and which content point are active for each file system view, and
wherein the workspace client store receives and transmits the identities and network address of every attached workspace client apparatus.

13. A method for operating a system comprising the steps:
within each workspace client apparatus
exchanging with other workspace clients file information,
responding to requests for managed file from a workstation,
presenting a file state view to a user,
updating a file state server with state information for each file in the file state view. within a file state server apparatus
receiving and serving file state information,

14. The method of claim 13 further comprising
stashing redundant file copies at workspace clients which do not have a file state view of them, and
removing inactive content points unneeded by any file state view.

15. A method for operating a workspace client apparatus comprising the following processes:
updating managed file information comprising
receiving information about workspace clients from other workspace clients
receiving information about workspace clients from the file state server presenting a file system view of files managed by the file state server presenting a file system view of unmanaged files local to the workspace client providing managed files to other workspace clients
upon receiving a network request for a managed file from a peer workspace client,
examining local file store for requested file,
transmitting change log for requested file,
transmitting content point for request file,
transmitting identities of workspace clients known to have the requested file,
exchanging updated file state views of managed files;
upon receiving a local user file write
storing the file to locally attached file store,
if the file is a managed file,
determining a change log to a content point,
transmitting to a file state server apparatus the current file state,
updating the file system view;
upon receiving a local user file read
retrieving the file from locally attached file store,
if the file is a managed file not in locally attached file store,
if possible, satisfy request from within current holdings, and
if possible, satisfy request from other workstation client.

16. The method of claim 15 further comprising
receiving a change log for a file,
receiving a content point for a file,
receiving and combining file parts from a plurality of sources.

17. The method of claim 15 further comprising
optimizing workspace client information exchange
each Workspace maintaining change logs over a finite range
if possible, exchanging only incremental changes, and
otherwise, exchanging full state.

18. The method of claim 15 further comprising
choosing suitable peer workspace clients,
collecting statistics about performance and reliability of other workspace clients, and
recording the frequency of network link failures.

19. The method of claim 15 further comprising receiving, storing, retrieving and serving a hierarchical tree of data blocks comprising data blocks which are encrypted and data blocks which are not encrypted whereby a file system view circuit can provide its peers with data blocks which the file system view circuit cannot itself decipher for its own use.

20. The method of claim 15 further comprising committing a file comprising the following processes:
making a file visible to all peers,
archiving a file to a central store,
updating a file state server with a new version control parameter, and
updating a file system view of the file from pre-managed to managed.
